(19) United States
(12) Patent Application Publication
(10) Pub. No.: US 2004/0143945 A1
(43) Pub. Date: Jul. 29, 2004

(54) Hinge locking carabiner

(76) Inventor: Tony Christianson, Yosemite, CA (US)

Correspondence Address: Tony Christianson, 2007 Wawona Station, Yosemite, CA, 95389, US

(21) Appl. No.: 10/759,982

(22) Filed: Jan. 16, 2004

Related U.S. Application Data
(63) Continuation-in-part of application No. 10/309,599, filed on Dec. 3, 2002.
(60) Provisional application No. 60/339,524, filed on Dec. 8, 2001.

(51) Int. Cl. F16B 45/02

(52) U.S. Cl. 24/600.1

(57) ABSTRACT

The instant invention is a compact carabiner locking mechanism contained within the carabiner gate. The locking mechanism incorporates a means to disable the gate return spring mechanism and thereby prevent movement of the gate. A low profile external protrusion on one side of the gate is pushed to unlock the gate return spring mechanism, which allows the gate to be opened. Similarly, another low profile external protrusion on the other side of the gate is pushed to lock the gate return mechanism. The locking and unlocking protrusions are located adjacent the gate hinge so that the carabiner gate can be conveniently unlocked, opened and relocked with one hand.

### RELATED APPLICATIONS AND DISCLOSURE DOCUMENTS

The instant invention is a continuation-in-part of application Ser. No. 10/309,599 filed Dec. 3, 2002, which claims priority of Provisional Application No. 60/339,524 filed Dec. 8, 2001.

The instant application is also related to Disclosure Documents No. 500828 deposited Oct. 5, 2001 and No. 456950 deposited May 25, 1999; and now abandoned Provisional Applications No. 60/295,681 filed Jun. 2, 2001 and No. 60/197,748 filed Apr. 17, 2000.

### BACKGROUND OF THE INVENTION

1. Field of the Invention

The instant invention is generally related to climbing aids for rock climbers. More particularly, this invention is related to mechanical devices that link climbing aids together.

2. Description of the Prior Art

Climbers utilize rope, slings and a variety of mechanical devices as climbing aids to assist and protect their movement over rock. The climbing aids serve as a means to anchor the climber to the rock for the purpose of either preventing or arresting a fall.

A carabiner is a mechanical device used to link rope, slings and other climbing aids together. A carabiner is essentially a snap-hook used, for example, to attach a climber's body harness to the climbing rope. It is also used to link the climbing rope to anchors placed in or over the rock.

A typical carabiner is a palm sized, oblong or oval or “D” shaped ring of a lightweight, high strength material, usually a heat-treated aluminum alloy. One side of the carabiner has a hinged arm that serves as an inward opening gate. The gate is spring loaded to remain normally closed.

The normally closed, inward opening gate facilitates insertion of climbing aids, but impedes inadvertent removal. Objects are released from the carabiner after manually pushing open the gate.

The closing force iso provided by a stout compression spring that is housed within the carabiner gate. The spring axis is offset from the pivot pin so that the spring force is directed to close the gate. A link is employed to transfer the spring force to the carabiner body at an appropriate distance from the pivot pin.

The opening end of the gate incorporates a transverse pin that engages a hooked notch in the carabiner body when the gate is completely closed. This arrangement allows the gate to carry part of the load imposed on the carabiner. Consequently, the carabiner is significantly stronger when the gate is closed. The ultimate strength of a carabiner with the gate open is typically 65% lower than with the gate closed.

During a climb and especially in the event of a fall, the climber's safety is dependent on the security of numerous carabiner links. Consequently, it is imperative that every carabiner in the chain be able to withstand not only the weight of the climber but also the inertial forces generated when the rope arrests a fall.

As the climber progresses the carabiners in a protective chain of climbing aids often rub against the rock. Occasionally, a carabiner gate will catch on a rock or other object and may be pushed open without the climber's knowledge. Also, during a fall a carabiner will often slap against the rock causing inertial loads that overcome the closing force of the spring and momentarily open the gate.

Whenever the gate opens, even momentarily, there is significant risk that a rope or other climbing aid will be inadvertently released. Furthermore, if a sudden load is applied to the carabiner at the instant that the gate is open, the ultimate strength of the carabiner is significantly compromised and very possibly may fail. Such occurrences are well known by the climbing community and are considered a major problem.

Greater security can be obtained by using two carabiners in parallel with the gates opening in opposite directions. However, extra carabiners for the purpose of parallel placement are undesirable because they add considerably to the weight and bulk that the climber must carry. Accordingly, various means have been developed to lock the carabiner gate closed.

A popular solution to the problem incorporates a locking sleeve that is threaded, nut like, to the gate. The sleeve can be screwed along the length of the gate, either toward the hinge, or toward the opening end. The sleeve is screwed into the locking position after the rope or other climbing aids have been clipped into the carabiner. In one configuration the gate is locked closed by screwing the sleeve until it crosses the opening end of the gate and jams against the adjacent body of the carabiner. In an alternate configuration the gate is immobilized when the sleeve is screwed over the hinge.

Unfortunately, threaded locking sleeves undesirably add bulk and weight to the carabiner. Threaded locking sleeves are also inherently troublesome. The threads can become clogged with dirt or ice. The sleeve can inadvertently screw out of the locked position when the carabiner rubs across the rock. Furthermore, the gate and threaded sleeve mechanism require precise machining and assembly alignment, both of which add significantly to manufacturing cost.

Other solutions of the prior art include gates equipped with spring loaded sliding and/or rotary sleeves. Sliding and/or rotary sleeves function similarly to threaded sleeves. Sliding and rotary sleeves share the same problems as threaded sleeves, and are especially costly to manufacture.

The increased bulk, weight and cost of the prior art limits the number of locking carabiner that a climber is able to carry during a climb or is willing to buy in the first place. Consequently, there may be situations during a climb when the climber is compelled to use a non-locking carabiner although a locking type would be preferable or safer.

The instant invention is a carabiner incorporating a locking mechanism that securely and reliably locks the gate closed. The inventive locking mechanism is contained inside the gate; therefore it does not add bulk or weight to the carabiner and is less susceptible to jamming by dirt or ice. The gate can be unlocked, opened and relocked with one hand. In addition, compared to the prior art, the preferred configuration of the instant invention is significantly less costly to manufacture.

### SUMMARY OF THE INVENTION

The instant invention is a compact carabiner locking mechanism contained within the carabiner gate. The locking mechanism incorporates a means to disable the gate return spring mechanism and thereby prevent movement of the gate. A low profile external protrusion on one side of the gate is pushed to unlock the gate return spring mechanism, which allows the gate to be opened. Similarly, another low profile external protrusion on the other side of the gate is pushed to lock the gate return mechanism. The locking and unlocking protrusions are located adjacent the gate hinge so that the carabiner gate can be conveniently unlocked, opened and relocked with one hand.

### DESCRIPTION OF THE DRAWINGS

A detailed description of the invention is made with reference to the accompanying drawings wherein like numerals designate corresponding parts in the several FIGS.

FIG. 1 is a pictorial view of the inventive carabiner linking rope and webbing.

FIG. 2 is a side elevation view of a carabiner incorporating the preferred configuration of the inventive locking mechanism.

FIG. 5 is a top view of the carabiner as seen in the direction 3-3 of FIG. 2.

FIG. 4 is a partial sectional view of the inventive carabiner, taken along a cut corresponding to line 4-4 of FIG. 3, showing the locking mechanism locked.

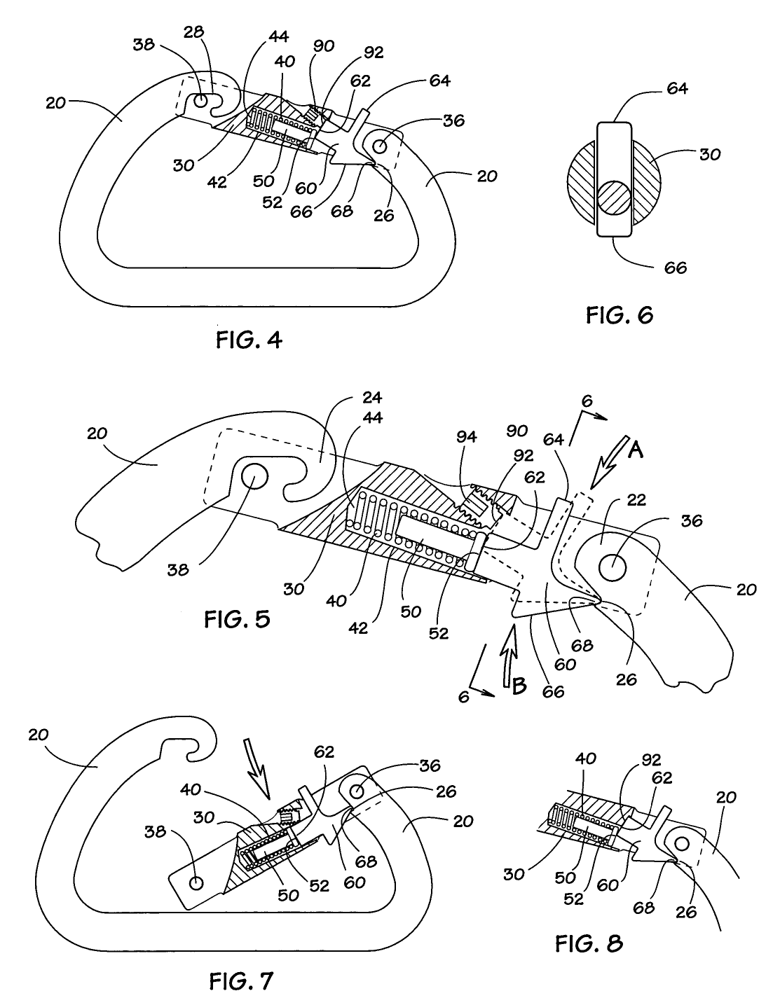

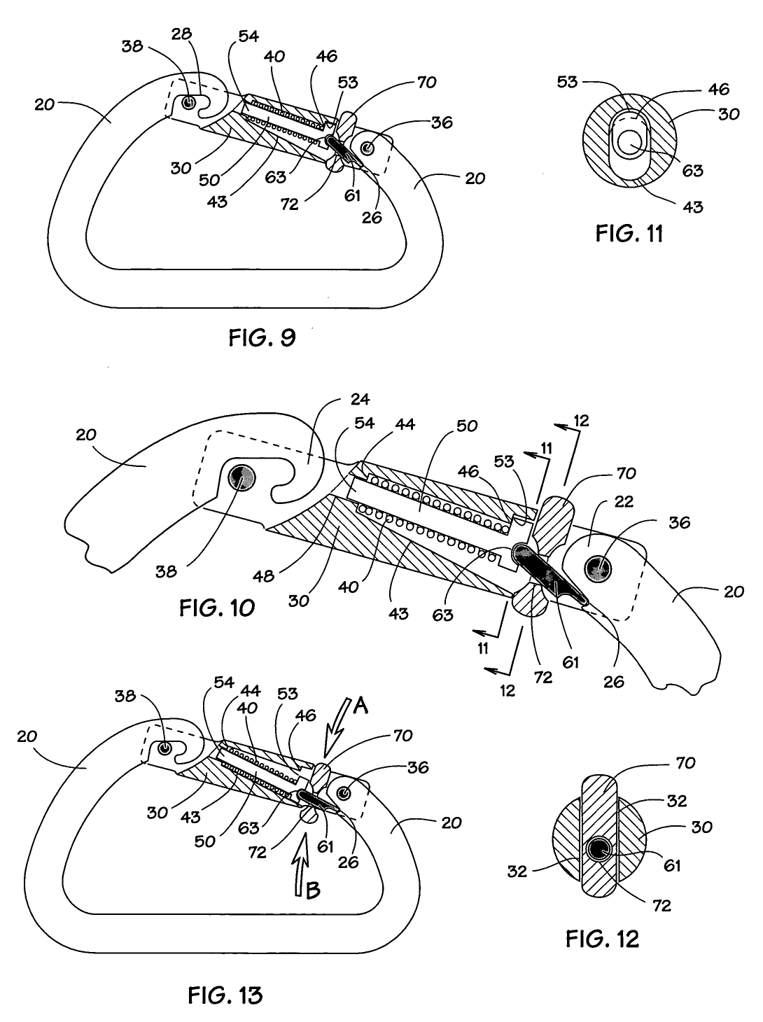

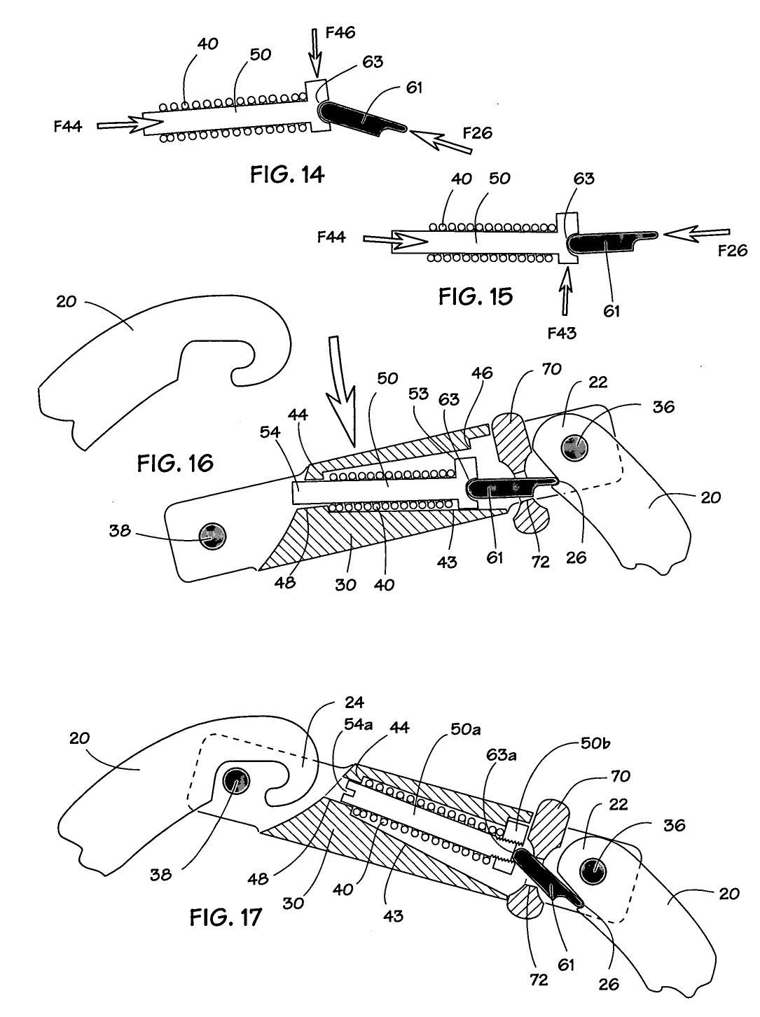

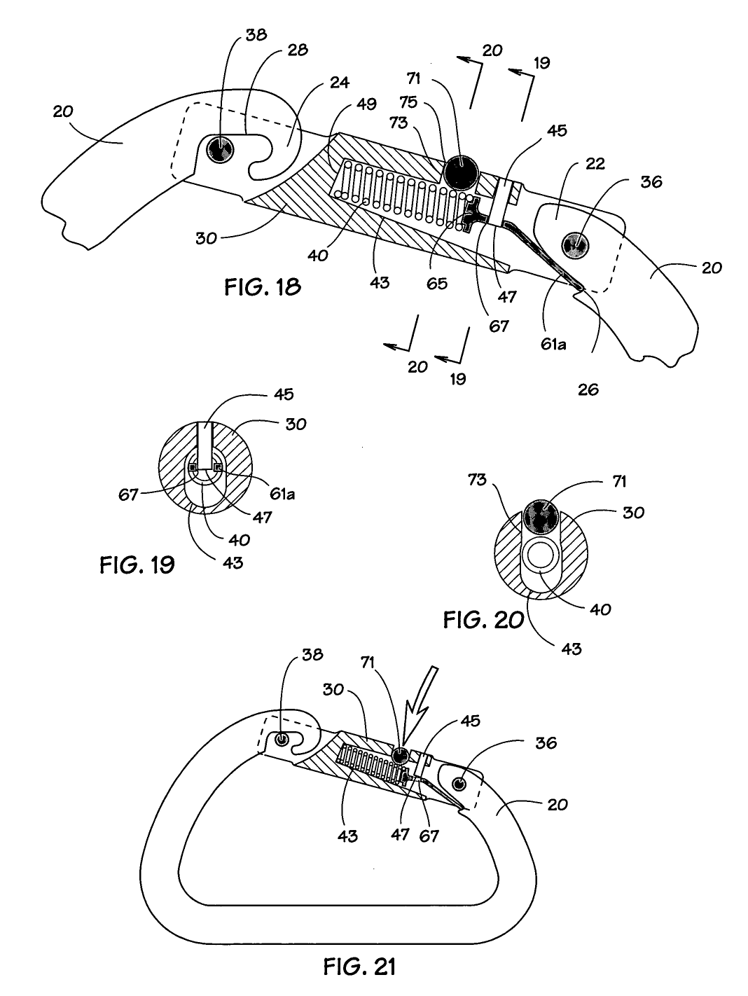

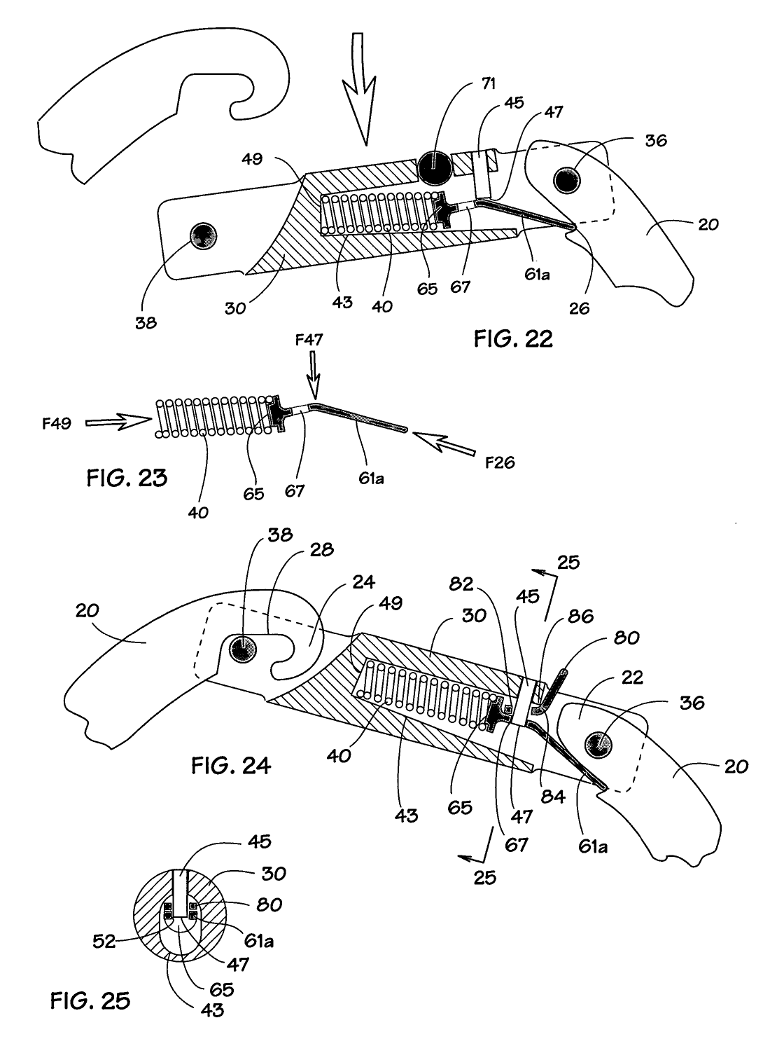

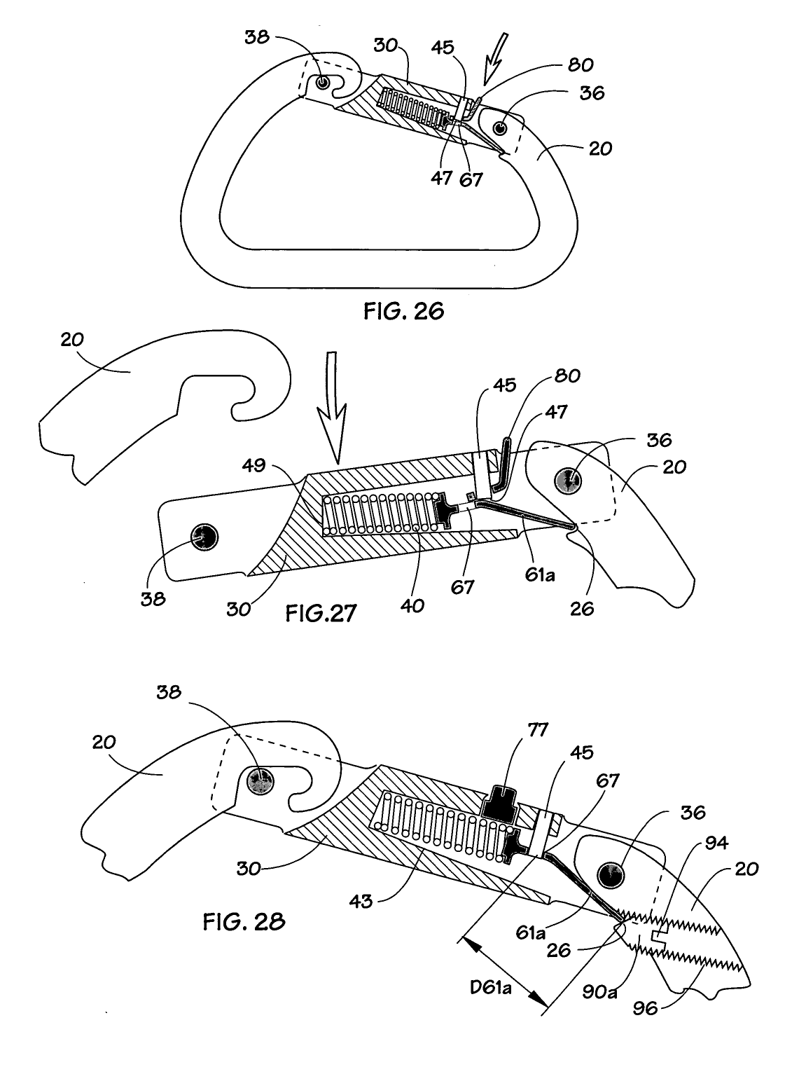

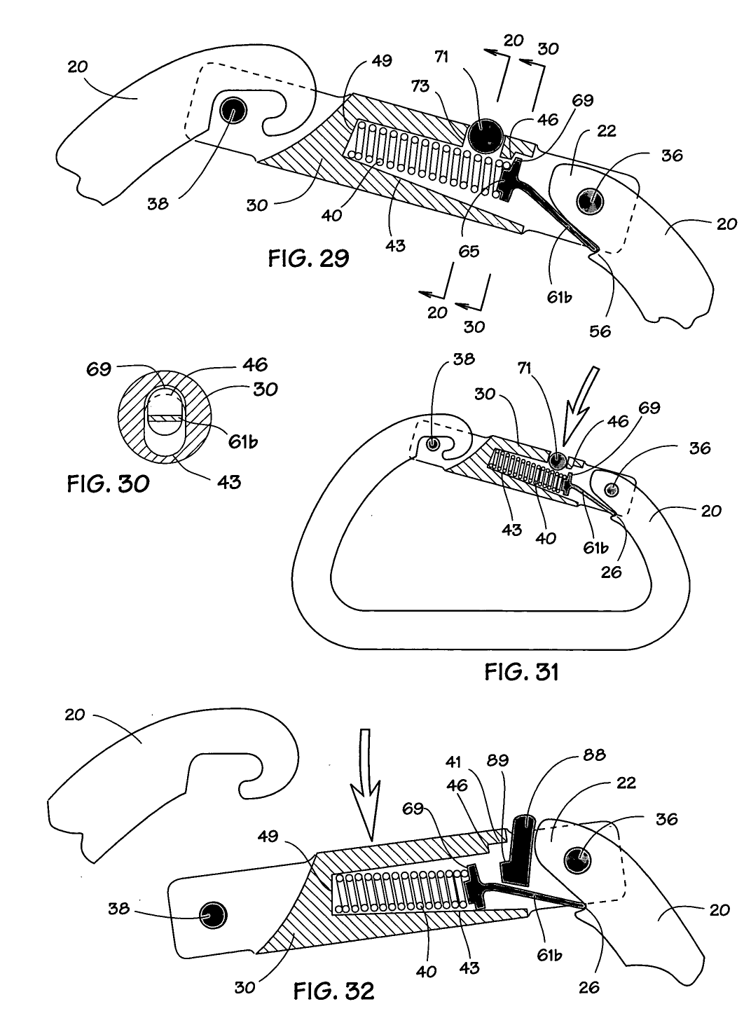

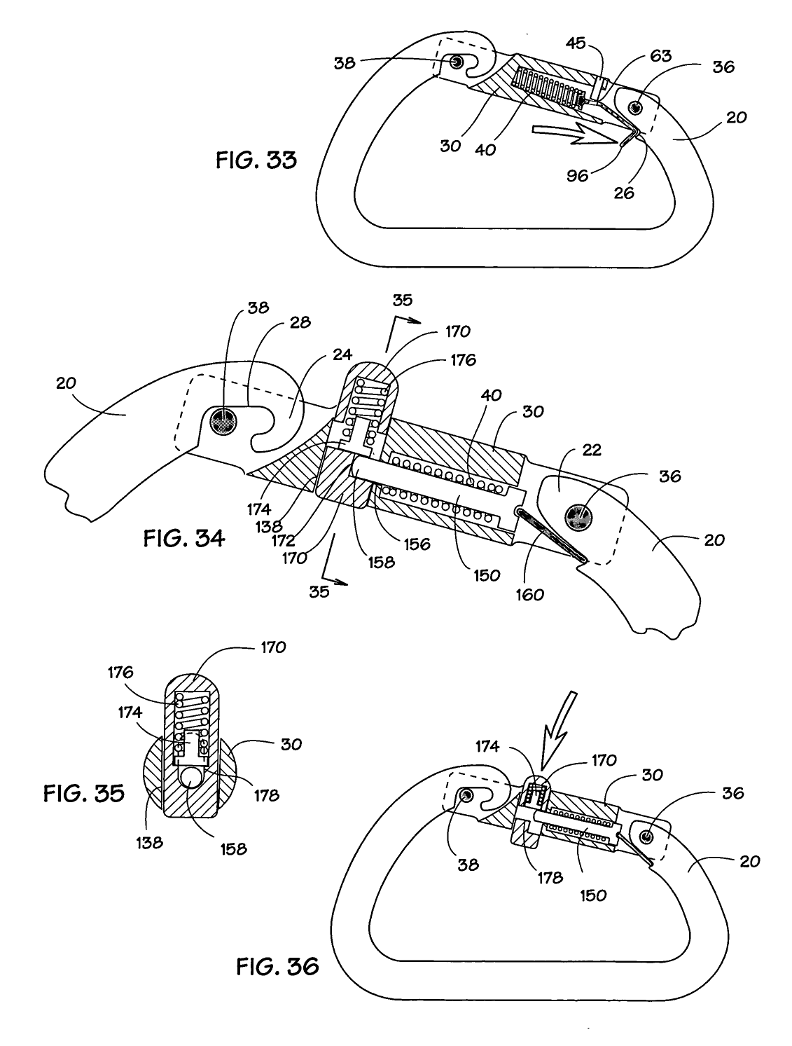

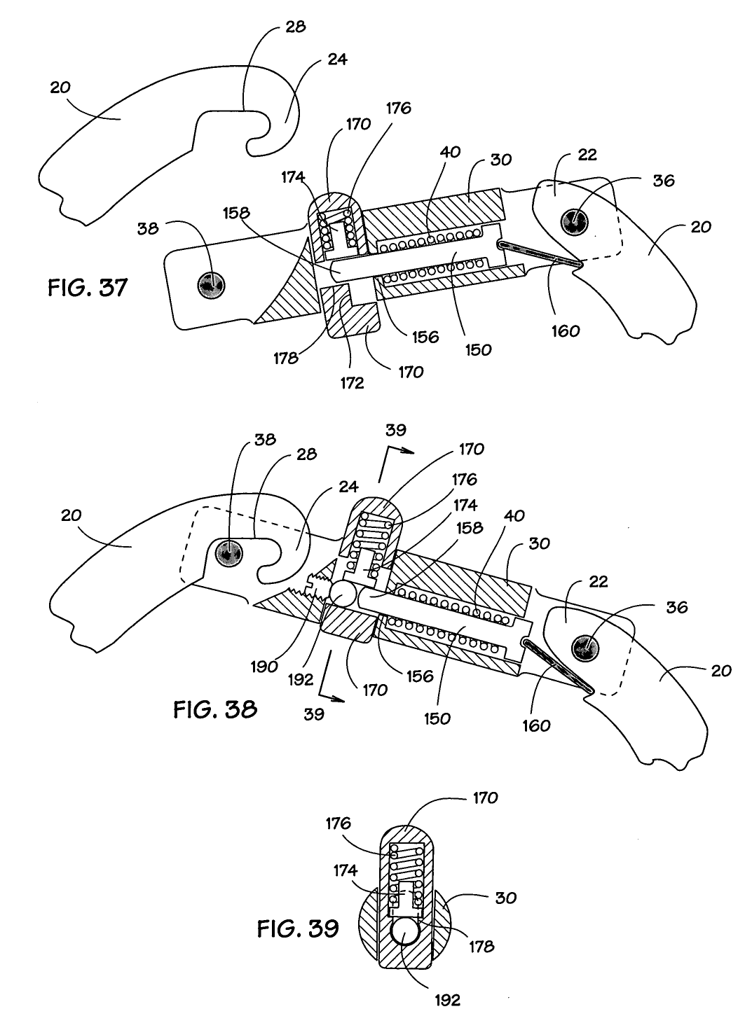

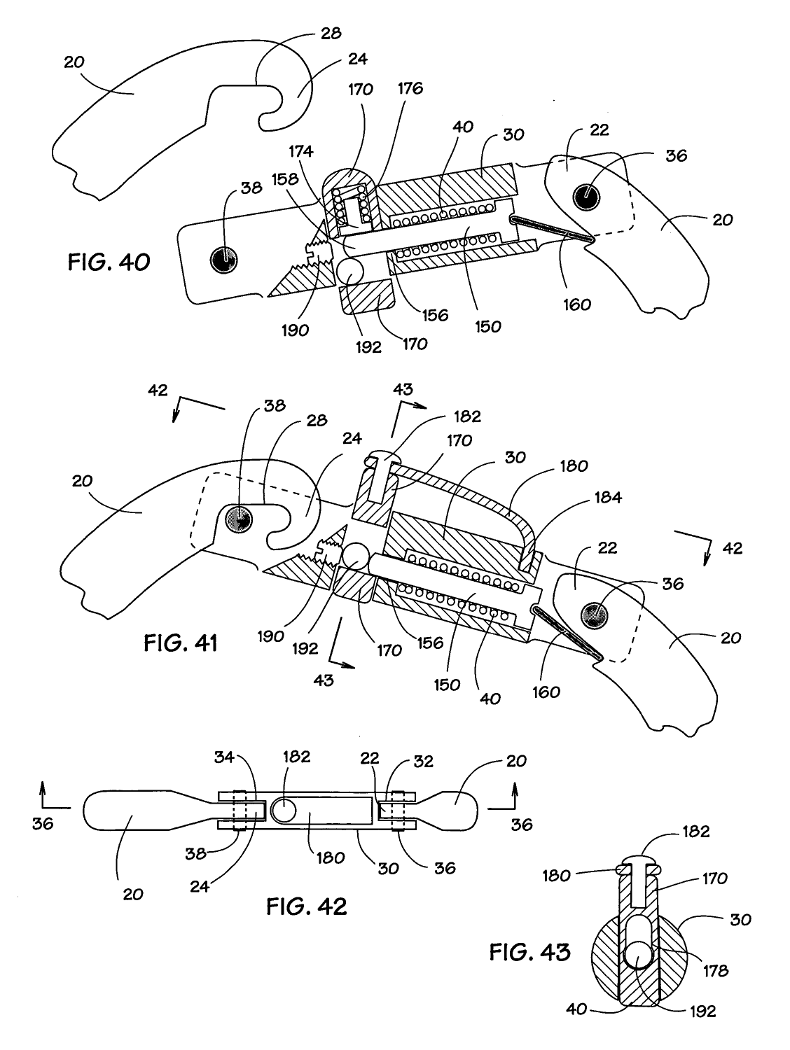

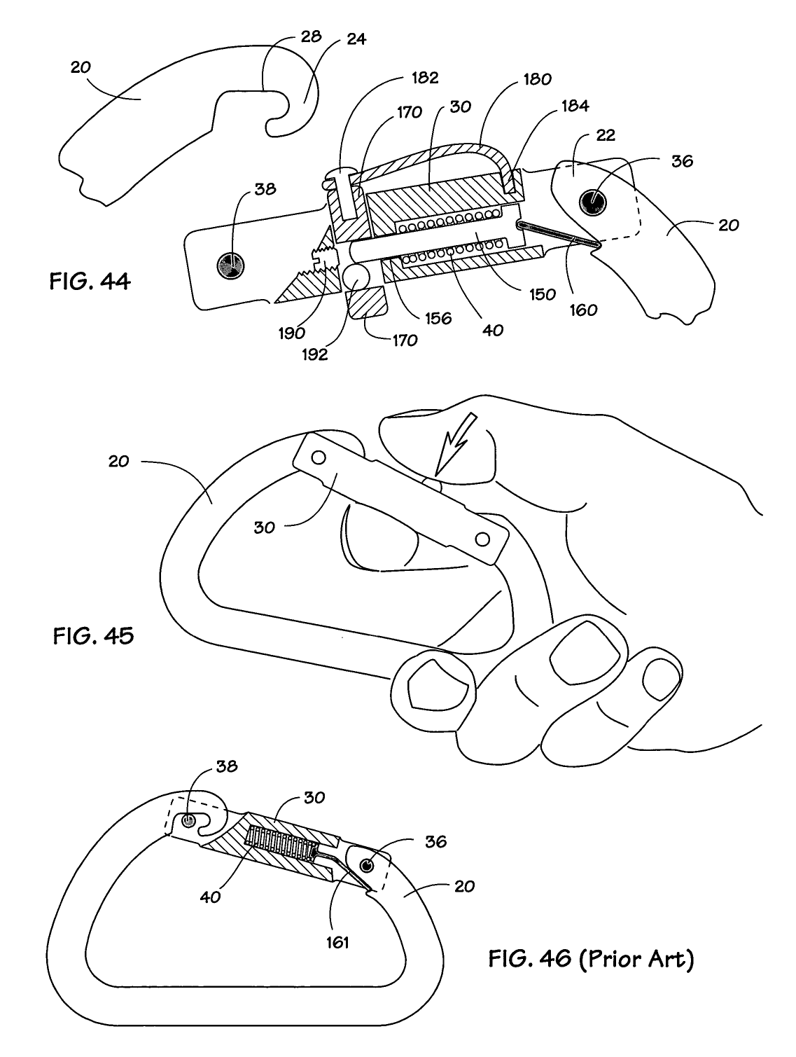

FIG. 5 is a partial close-up sectional view of the carabiner of FIG. 4.

FIG. 6 is a sectional view of the carabiner, taken alone a cut corresponding to line 6-6 of FIG. 5.

FIG. 7 is a partial sectional view of the carabiner of FIG. 4, showing the locking mechanism unlocked and the gate open.

FIG. 8 is a partial sectional view showing an alternate configuration of the locking mechanism of FIG. 4.

FIG. 9 is a partial sectional view of an alternate configuration the inventive carabiner, showing the locking mechanism locked.

FIG. 10 is a partial close-up sectional view of the carabiner of FIG. 9.

FIG. 11 is a sectional view of the carabiner, taken alone a cut corresponding to line 11-11 of FIG. 10.

FIG. 12 is a sectional view of the carabiner, taken along a cut corresponding to line 12-12 of FIG. 10.

FIG. 13 is a partial sectional view of the carabiner of FIG. 9, showing the locking mechanism unlocked.

FIG. 14 is a free-body diagram of the spring and link assembly in the locked position.

FIG. 15 is a free-body diagram of the spring and link assembly in the unlocked position.

FIG. 16 is a partial close-up sectional view of the carabiner of FIG. 9, showing the gate partially open.

FIG. 17 is a partial close-up sectional view of another alternate configuration of the inventive carabiner.

FIG. 18 is a partial close-up sectional view of yet another alternate configuration of the inventive carabiner.

FIG. 19 is a sectional view of the carabiner of FIG. 18, taken along a cut corresponding to line 19-19.

FIG. 20 is a sectional view of the carabiner of FIG. 18, taken along a cut corresponding to line 20-20.

FIG. 21 is a partial sectional view of the carabiner of FIG. 18, showing the locking mechanism unlocked just prior to opening the gate.

FIG. 22 is a partial close-up sectional view of the inventive carabiner of FIG. 21, showing the gate partially open.

FIG. 23 is a free-body diagram of the spring and link assembly of the carabiner of FIG. 22.

FIG. 24 is a partial close-up sectional view of yet another alternate configuration of the inventive carabiner.

FIG. 25 is a sectional view of the carabiner, taken along a cut corresponding to line 25-25 of FIG. 24.

FIG. 26 is a partial sectional view of the carabiner of FIG. 24, showing the locking mechanism unlocked just prior to opening the gate.

FIG. 27 is a partial close-up sectional view of the inventive carabiner of FIG. 24, showing the gate partially open.

FIG. 28 is a partial close-up sectional view of yet another alternate configuration of the inventive carabiner.

FIG. 29 is a partial close-up sectional view of yet another alternate configuration of the inventive carabiner.

FIG. 30 is a sectional view of the carabiner of FIG. 29, taken along a cut corresponding to line 30-30 of FIG. 29.

FIG. 31 is a partial sectional view of the carabiner of FIG. 29, showing the locking mechanism unlocked just prior to opening the gate.

FIG. 32 is a partial close-up sectional view of another alternate configuration of the inventive carabiner, showing the gate partially open.

FIG. 33 is a partial close-up sectional view of yet another alternate configuration of the inventive carabiner, showing the locking mechanism unlocked just prior to opening the gate.

FIG. 34 is a partial close-up sectional view of yet another alternate configuration of the inventive carabiner.

FIG. 35 is a sectional view of the carabiner of FIG. 34, taken along a cut corresponding to line 35-35.

FIG. 36 is a partial sectional view of the carabiner of FIG. 34, showing the locking mechanism unlocked just prior to opening the gate.

FIG. 37 is a partial close-up sectional view of the carabiner of FIG. 34, showing the gate partially open.

FIG. 38 is a partial close-up sectional view of yet another alternate configuration of the inventive carabiner.

FIG. 39 is a sectional view of the inventive carabiner of FIG. 38, taken along a cut corresponding to line 39-39.

FIG. 40 is a partial close-up sectional view of the inventive carabiner of FIG. 38, showing the gate partially open.

FIG. 41 is a partial close-up sectional view of yet another alternate configuration of the inventive carabiner.

FIG. 42 is a top view of the carabiner of FIG. 41 as seen in the direction 42-42.

FIG. 43 is a sectional view of the inventive carabiner of FIG. 41, taken alone a cut corresponding to line 43-43.

FIG. 44 is a partial close-up sectional view of the inventive carabiner of FIG. 41, showing the gate partially open.

FIG. 45 is a pictorial view showing one hand unlocking the inventive locking mechanism and opening the gate.

FIG. 46 is a partial sectional view of a typical carabiner of the Prior Art.

### DESCRIPTION OF THE PREFERRED EMBODIMENT

The following detailed description is of the best presently contemplated modes of carrying out the invention. This description is not to be taken in a limiting sense, but is made merely for purposes of illustrating the general principles of the invention.

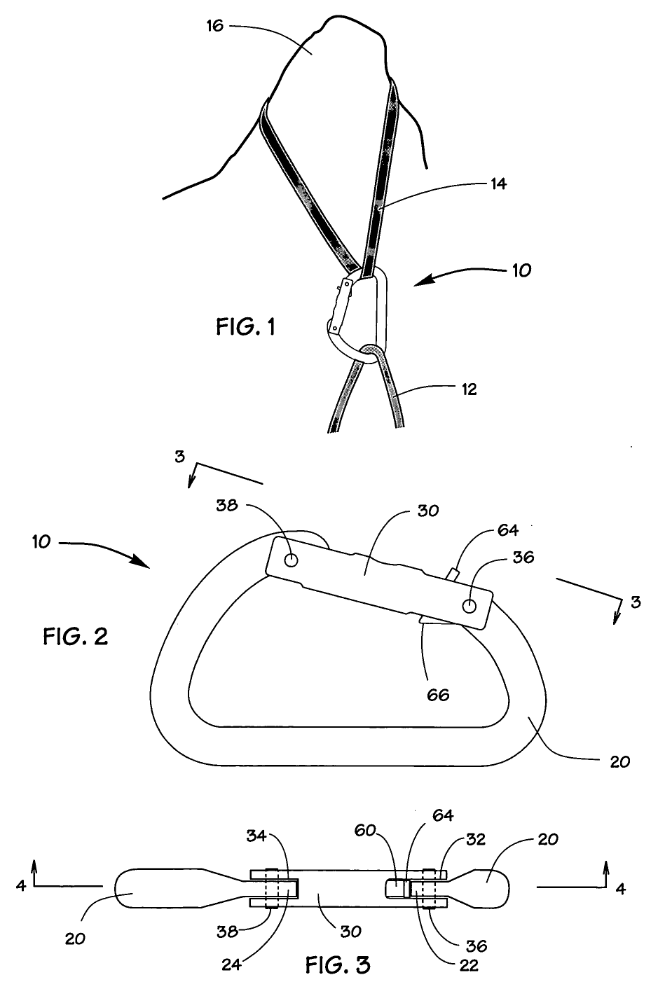

Referring to FIG. 1, inventive carabiner 10 is shown linking climbing rope 12 to webbing 14 looped around rock 16. FIG. 1 exemplifies one of the many ways that a carabiner can be used to link climbing aids together.

Referring to FIG. 2, carabiner 10 includes body 20 and gate 30. The inventive locking mechanism is contained within gate 30; only a portion of control 60 protrudes externally at 64 and 66. Body 20 and gate 30 are fabricated from a lightweight, high strength material, for example aluminum alloy type 7075 heat treated to condition T6.

The preferred configuration of the inventive locking mechanism is illustrated by FIGS. 2-7. The terms “top” and “bottom”; “above” and “below” refer to the orientation of carabiner 10 shown by FIG. 2.

Referring to FIG. 3, gate 30 is slotted at both ends by parallel slots 32 and 34. Leg ends 22 and 24 of body 20 nest loosely within the confines of slots 32 and 34 respectively. Gate 30 is hinged to body 20 by pin 36 which transverses slot 32 through a slip-fitting hole in leg end 22.

Referring to FIGS. 3 and 4, the opening end of gate 30 includes pin 38 which transverses slot 34. When gate 30 is closed, pin 38 rests against the top of notch 28 in body 20, thereby limiting the closing movement of gate 30. Notch 28 also serves to capture pin 38 when high tensile loads reform body 20, thereby enabling gate 30 to carry part of the load transmitted through body 20.

Alternate means of limiting the travel of gate 30 are possible. For example, forming the end of gate 30 to abut directly against a mating recess of body 20 can eliminate pin 38. As another alternative, the end of gate 30 and the associated leg of body 20 can be formed or machined to provide an interlocking relationship that transmits tensile loads.

Referring to FIG. 5, gate 30 is held in the closed position by the combined action of compression spring 40, spring pin 50 and control 60. Compression spring 40 and spring pin 50 are loosely contained within hole 42. Hole 42 opens into slot 32 and the axis of hole 42 is approximately parallel to the axis of gate 30.

Compression spring 40 is typically fabricated by coiling a corrosion resistant material, for example 17-7 PH stainless steel spring wire. Machining or forging a corrosion resistant material, for example brass, is a typical way to fabricate spring pin 50. Machining, swaging or forging a corrosion resistant material, for example brass or stainless steel, are typical ways to fabricate control 60.

Compression spring 40, in conjunction with spring pin 50, applies a force in one direction against abutment 44 at the bottom of hole 42 and in the other direction against surface 62 of control 60. Control 60 transmits the force through tip 68 to notch 26 on body 20. Notch 26 is adjacent but offset inward from the center of hinge pin 36. The offset distance provides the leverage which forces gate 30 closed.

Referring again to FIGS. 2 and 3, control 60 is located within slot 32 adjacent leg 22 of body 20. Control 60 transverses the width of gate 30, and protrudes slightly beyond the top of gate 30 at 64, and slightly below gate 30 at 66. Sufficient clearance is provided between slot 32 and control 60 so that control 60 can move without binding.

Tip 68 of control 60 nests within notch 26, however control 60 is free to pivot around notch 26. Referring to FIG. 7, when an external force (depicted by the outline arrow in FIG. 7) causes gate 30 to open, control 60 pushes spring pin 50 into hole 42, compressing spring 40. Opening movements of gate 30 causes tip 68 to pivot around notch 26. For gate 30 to open, that portion of control 60 having surface 62 must move with pin 50 into hole 42. When gate 30 is open, the force of spring 40 against control 60 urges gate 30 to return to the closed position.

Referring to FIG. 5, control 60 can be pushed either up or down as depicted by the outline arrows “A” and “B” respectively. Movement of control 60 by force “A” is facilitated by protrusion 64. Movement of control 60 by force “B” is facilitated by protrusion 66. Moving control 60 in the direction of arrow “A” causes control 60 to move to the unlocked position. Moving control 60 in the direction of arrow “B” causes control 60 to move to the locked position (control 60 is shown in the locked position as a dashed line in FIG. 5.)

Referring to the locked position shown in FIGS. 4 and 5, surface 62 of control 60 abuts surface 92 of setscrew 90. The abutment of surface 62 with surface 92 prevents that portion of control 60 having surface 62 from moving into hole 42, which thereby disables the opening action of return spring 40 and immobilizes gate 30.

As described supra, when surface 62 abuts surface 92, gate 30 cannot move. For the inventive carabiner to be assembled and function properly, manufacturing tolerances must be controlled so that surface 62 makes direct contact with surface 92 when gate 30 is closed. However, contact between surfaces 62 and 92 must be loose enough to allow pivotal movement of control 60. If control 60 is fabricated so that a significant gap exists between surfaces 62 and 92, some opening movement of gate 30 will occur even when the two surfaces are engaged. Conversely, if control 60 is fabricated oversize, it will not be possible to engage surfaces 62 and 92. Setscrew 90 is utilized to avoid these problems.

Setscrew 90 is provided so that the location of surface 92 can be adjusted relative to surface 62 to compensate for dimensional variations of the various components. Screwing setscrew 90 in or out with respect to gate 30 adjusts the location of surface 92, thereby providing the proper clearance between surfaces 62 and 92. End 94 of setscrew 90 is configured to facilitate adjustment by a screwdriver or socket-driver or-the-like after the carabiner has been assembled.

During assembly of the inventive carabiner, setscrew 90 is somewhat retracted to provide ample clearance between the various components. After the inventive carabiner is 0 control 60 is moved to the locked position and setscrew 90 is adjusted until surface 92 just makes contact with surface 62. At the point where surface 92 makes proper contact with surface 62, gate 30 will be unable to open unless control 60 is moved to the unlocked position. After setscrew 90 is properly adjusted, a thread locking-compound, for example locktite, can be used to preserve the adjustment.

Alternately, as shown in FIG. 8, surface 92 can be machined as part of gate 30. If surface 92 is machined a part of gate 30, dimensional tolerances of the various components must be precisely controlled to provide the correct fit.

Referring to the unlocked position shown in FIG. 5, the movement of control 60 in direction “A” has moved surface 62 away from setscrew 90. When surface 62 completely lines-up with surface 52 of spring pin 50, control 60 will be able to move axially with spring pin 50 into hole 42; therefore gate 30 can be opened as shown in FIG. 7.

The locations of surfaces 52, 62 and 92 with respect to notch 26, are chosen to enable control 60 to have two stable positions, either locked or unlocked. As such, control 60 operates as a switch that can be pivoted from one stable position to the other by either pushing against protrusion 64 or protrusion 66 as described supra. Movement from the locked to the unlocked position, and the opposite, produces an audible “snap” that can be heard by the climber. In addition, the position of control 60, either up or down, provides a visual and tactile indication of the state of the inventive locking mechanism.

Climbers are often in precarious positions in which only one hand is available to insert a climbing aid or rope into a carabiner (typically the other hand is occupied holding on to another climbing aid or the rock surface). Under such circumstances it may be imperative that the carabiner be easily unlocked and opened and subsequently relocked with only one hand. Because the inventive locking carabiner of FIGS. 2-7 has two stable positions, either locked or unlocked, and control 60 can be easily moved with one finger, a climber can first unlock the carabiner, open and close gate 30 as many times as need, and when appropriate, relock the carabiner, all with the use of one hand.

FIGS. 9-16 shows an alternate configuration of the instant invention.

Referring to FIG. 9, gate 30 is held in the closed position by the combined action of compression spring 40, spring pin 50 and link 61. Compression spring 40 and spring pin 50 are loosely contained within hole 43. Hole 43 opens into slot 32 and the axis of hole 43 is approximately parallel to the axis of gate 30. As best seen in FIG. 11, hole 43 has an oblong cross section.

Compression spring 40, in conjunction with spring pin 50, applies a force in one direction against abutment 44 at the bottom of hole 43 and in the other direction against joint 63 between spring pin 50 and link 61. Link 61 transmits the force to notch 26 on body 20. Notch 26 is adjacent but offset inward from the center of hinge pin 36. The offset distance provides the leverage which forces gate 30 closed. When gate 30 opens, link 61 pushes spring pin 50 into hole 42, compressing spring 40. When gate 30 is open, the force of spring 40 against link 61 urges gate 30 to return to the closed position.

Lock button 70 is located within slot 32 adjacent leg 22 of body 20. Lock button 70 transverses the width of gate 30. Link 61 passes loosely through hole 72, which transverses lock button 70, thereby retaining lock button 70 within slot 32. The longitudinal axis of lock button 70 is approximately perpendicular to the longitudinal axis of gate 30, and intersects the longitudinal axis of hole 42. Sufficient clearance is provided between slot 32 and lock button 70 so that lock button 70 can move without binding.

Referring to FIG. 13, lock button 70 can be pushed either in or out as depicted by the outline arrows “A” and “B” respectively. Moving lock button 70 in one direction or the other pushes against link 61 at the location where link 61 passes through hole 72. One end of link 61 is restrained axially by notch 26, however link 61 is free to pivot around notch 26 thereby moving joint 63 between link 61 and spring pin 50.

Moving button 70 in the direction of arrow “A” causes link 61, spring 40 and spring pin 50 to move to the unlocked position shown in FIG. 13. Moving lock button 70 in the direction of arrow “B” causes link 61, spring 40 and spring pin 50 to move to the locked position shown in FIGS. 9 and 10.

Referring to the locked position shown in FIGS. 9 and 10, shoulder 53 of spring pin 50 abuts shelf 46 in hole 42. The engagement of shoulder 53 with shelf 46 blocks the opening movement of spring pin 50 and thereby immobilizes gate 30.

Referring to the unlocked position shown in FIG. 13, the movement of button 70 in direction “A” has moved shoulder 53 away from shelf 46. Without the engagement of shoulder 53 with shelf 46, spring pin 50 is free to move axially within hole 43; therefore gate 30 can be opened as shown in FIG. 16. In FIG. 16, the outline arrow depicts the force opening gate 30.

Referring to FIG. 10, end 54 of spring pin 50 passes through hole 48 at the bottom of hole 43. Sufficient clearance is provided between spring pin 50 and hole 48 so that spring) pin 50 can move axially without binding. The difference between the diameters of hole 43 and hole 48 provide abutment 44 for one end of spring 40. Hole 48 provides guidance for the axial movement of spring pin 50. Alternately, hole 46 can be eliminated, spring pin 50 shortened, and guidance of spring pin 50 provided by spring 40 itself.

The location of abutment 44 with respect to notch 26, and the dimensions of hole 43 are chosen to enable spring pin 50 and link 61 to have two stable positions, either locked or unlocked. As such, spring pin 50 and link 61 operate as an over-center switch that can be changed from one stable position to the other by moving button 70. Movement from the locked to the unlocked position, and the opposite, produces an audible “snap” that can be heard by the climber. In addition, the position of button 70, either up or down, provides a visual and tactile indication of the state of the inventive locking mechanism.

FIG. 14 is a free-body diagram of spring 40, spring pin 50 and link 61 showing the forces acting on the assembly when in the locked position. F44 is the force against spring 40 from abutment 44. F26 is the force against link 60 from notch 26. Because the forces F44 and F26 are offset upward when in the locked position, joint 63 between spring pin 50 and link 61 will buckle upward, which is resisted by F46 from shelf 46.

Similarly, FIG. 15 is a free-body diagram of spring 40, spring pin 50 and link 61 showing the forces acting on the assembly when in the unlocked position. F44 is the force against spring 40 from abutment 44. F26 is the force against link 61 from notch 26. Because the forces F44 and F26 are offset downward when in the unlocked position, joint 63 between spring pin 50 and link 61 will buckle downward, which is resisted by F43 from the sidewall of hole 43.

As described supra, when shoulder 53 engages shelf 46, gate 30 cannot move. For the inventive carabiner to be assembled and function properly, manufacturing tolerances must be controlled so that shoulder 53 lines-up with shelf 46 when gate 30 is closed. If link 61 is fabricated too short, some opening movement of gate 30 will occur even when shoulder 53 and shelf 46 are engaged. Conversely, if link 61 is overlong, it will not be possible to engage shoulder 53 with shelf 46. These problems are avoided by the alternate configuration of FIG. 17.

FIG. 17 shows the configuration of FIG. 10, but spring pin 50 has been replaced by threaded rod 50a and nut 50b. Nut 50b provides shoulder 53 that engages shelf 46. Threaded rod 50a and nut 50b are adjusted to compensate for dimensional variations of the various components. Screwing rod 50a in or out with respect to nut 50b adjusts the location of joint 63a, thereby providing the proper engagement with link 61. Screwdriver slot 54a facilitates adjustment of rod 50a after the carabiner has been assembled.

During assembly of the inventive carabiner, threaded rod 50a is adjusted to provide ample clearance between the various components. After the inventive carabiner is assembled, threaded rod 50a is adjusted until shoulder 53 just makes contact with shelf 46. At the point when shoulder 53 makes contact with shelf 46, gate 30 will be unable to open unless lock button 70 is moved to the unlocked position.

Furthermore, other means of adjustment can be conceived. For example, the location of notch 26 can be adjusted by utilizing a setscrew, or the like, threaded at an angle into body 20 adjacent the proper location of notch 26 (see FIG. 28). This adjustment configuration will be described in more detail following.

FIGS. 18-32 shows alternate configurations of the instant invention. Referring to FIG. 18, lock release 71 is located within hole 73 in the top of gate 30. The center axis of hole 73 is approximately perpendicular to the longitudinal axis of gate 30, and intersects the center axis of hole 43. Sufficient clearance is provided between hole 73 and lock release 71 so that lock release 71 can move axially within hole 73 without binding.

Lock release 71 is retained within hole 73 by spring 40 at one end; and by indenting or peening outside corner 75 (see FIG. 18) to provide an interference fit that allows only a part of lock release 71 to protrude beyond the top surface of gate 30. Lock release 71 is preferably a rigid sphere fabricated of a corrosion resistant material, for example a type 316 stainless steel ball bearing. Alternately, lock release 71 can be a short cylindrical shape, or the like, for example a stepped cylindrical lock release 77 as shown in FIG. 28.

Referring to FIGS. 18 and 19, pin 45 is inserted through the top wall of gate 30 and extends approximately to the center of hole 43. The center axis of pin 45 is approximately perpendicular to the longitudinal axis of gate 30; and intersects the center axis of hole 43. Pin 45 is firmly attached to gate 30 by press-fit, welding, bonding, or the like. Pin 45 is preferably a hard, rigid, corrosion resistant material, for example a type 316 stainless steel rivet.

Referring again to FIGS. 18 and 19, the length of pin 45 is adjusted so that pin end 47 just barely passes through hole 67 in link 61a. Sufficient clearance is provided between hole 67 and pin 45 so that pin 45 can slip in and out of hole 67 without binding. When pin 45 is engaged with hole 67, movement of gate 30 is impossible because movement of link 61a, and subsequent compression of spring 40, is blocked. Without the movement of link 61a, gate 30 cannot open.

FIG. 21 shows lock release 71 pushed inward (the force pushing lock release 71 inward is depicted by the outline arrow). Inward movement of lock release 71 forces spring 40, and link 61a with it, to the other side of the oblong cross section of hole 43. Consequently, end 47 of pin 45 is disengaged from hole 67, freeing link 61a to move, and therefore gate 30 can be opened as shown in FIG. 22 (the outline arrow depicts the force opening gate 30.) Note that after gate 30 opens a small amount, hole 67 no longer lines up with pin 45 and consequently the force applied against lock release 71 is no longer needed.

FIG. 23 is a free-body diagram of spring 40 and link 61a showing the forces acting on the assembly. F49 is the force against spring 40 from end 49 of hole 43. F26 is the force against link 61a from notch 26 on body 20. Because the forces F49 and F26 are offset, joint 65 between spring 40 and link 61a will buckle upward, which is resisted by force F47 from end 47 of pin 45.

The force of spring 40 against link 61a urges gate 30 to return to the closed position. When gate 30 returns to the closed position, the buckling force will automatically move joint 65 upward as soon as hole 67 lines-up with pin 45, reengaging pin 45 with hole 67, which immediately blocks the opening movement of gate 30.

As described supra, when link 61a is at the locked position, gate 30 cannot move because pin 45 engages hole 67, which blocks movement of link 61a. For this configuration to be assembled and function properly, manufacturing tolerances must be controlled so that hole 67 lines-up with pin 45 when gate 30 is closed. Referring to FIG. 28, the distance D61 on link 61a between hole 67 and its end adjacent notch 26 must equal the distance between pin end 47 and notch 26 when gate 30 is closed. If link 61a is fabricated so that D61 is too short, some opening movement of gate 30 will occur even when pin 45 and hole 67 are engaged. Conversely, if D61 is fabricated overlong, it may not be possible to properly assemble the carabiner. These problems are avoided by the alternate inventive carabiner configuration of FIG. 28.

Referring to FIG. 28, setscrew 90a provides the means to adjust for dimensional variations of the various components. Setscrew 90a is threaded at an angle into body 20 adjacent the proper location of notch 26. The angle of the central axis of the thread is chosen so that the intersection of the surface of body 20 with the tip of setscrew 90a forms a notch for link 61a. Setscrew 90a has slot 94, or the like, to facilitate adjustment. By adjusting setscrew 90a in or out, the location of notch 26 will move so that it is possible to precisely locate notch 26 with respect to dimension D61.

The use of standard off-the-shelf components will lower manufacturing costs. Costs are kept low when fabricating the alternate configuration shown in FIGS. 18-22 by using a standard ball bearing for lock release 71, and a standard rivet for pin 45, However, lock release 71 requires that hole 73 be machined in the side wall of gate 30. FIGS. 24-27 shows another alternate configuration of the instant invention that eliminates the need for hole 73.

Referring to FIGS. 24-27, lock release 80 is am approximately L-shaped bracket having hole 82 in one leg. As best seen in FIGS. 24 and 25, the holed leg of lock release 80 is positioned in hole 43 between link 61a and the wall of gate 30. Pin 45 loosely passes through hole 82. The other leg of lock release 80 protrudes outward from slot 32 adjacent leg end 22 of body 20. The engagement of hole 82 with pin 45 holds lock release 80 at its proper location. Lock release 80 is typically fabricated by stamping and bending a corrosion resistant, rigid flat material, for example 316 stainless steel strip stock.

FIGS. 26 and 27 show lock release 80 pushed inward (the force pushing lock release 80 inward is depicted by the outline arrow in FIG. 26.) Inward movement of lock release 80 forces link 61a to the other side of the oblong cross section of hole 43, which disengages end 47 of pin 45 from hole 67. With link 61a free to move, gate 30 can be opened as shown in FIG. 27 (the outline arrow depicts the force opening gate 30.) Note that after gate 30 moves a small amount, hole 67 no longer lines up with pin 45 and consequently the force applied against lock release 80 is no longer needed.

The function and operation of the configuration of FIGS. 24-27 is the same as the function and operation of the configuration of FIGS. 18-23. The only difference is lock release 71 and associated hole 73 have been replaced with lock release 80, which does not require hole 73 because it is located in the gap between the hinge of gate 30 and body 20.

FIGS. 29-32 show yet another alternate configuration of the instant invention that eliminates the need for pin 45. Referring to FIGS. 29 and 30, shelf 46 is cut into the opening of hole 43. Shelf 46 serves the same function as pin 45. Extension 69 of link 61b extends upward a sufficient distance to engage shelf 46 when gate 30 is closed. Movement of link 61b is blocked when extension 69 engages shelf 46,

FIG. 31 shows lock release 71 pushed inward (the force pushing lock release 71 inward is depicted by the outline arrow). Inward movement of lock release 71 forces spring 40, and link 61b with it, to the other side of the oblong cross section of hole 42. Consequently, extension 69 of link 61b is disengaged from shelf 46, freeing link 61b to move, and therefore gate 30 can be opened.

Referring to FIG. 32, another configuration of the instant invention replaces lock release 71 with lock release 88. Lock release 88 is a stubby L-shaped member located adjacent leg 22 of body 20. Lock release 88 is held adjacent lee 22 by shoulder 89, which will abut against wall 41 should lock release 88 attempt to escape outward. Lock release 88 functions similarly to lock release 80. Lock release 88 is fabricated from a lightweight, rigid material, for example aluminum alloy type 6061.

FIG. 33 shows yet another configuration of the instant invention that eliminates the need for a separate lock release component. Link 61c has L-shaped leg 61d extending downward from notch 26 under hinge pin 36. When leg 61d is pushed sideways (depicted by the outline arrow) as shown in FIG. 33, link 61c pivots around notch 26 and hole 67 disengages from pin 45. The arrangement of FIG. 33 can be applied to the configurations of FIG. 29 as well.

In contrast to the configurations of FIGS. 4 and 9, which have two stable positions: locked or unlocked, the configurations illustrated by FIGS. 18-33 are always locked unless the release component is being pushed. Furthermore, the configurations illustrated by FIGS. 18-33 automatically lock as soon as gate 30 closes. However, as illustrated by FIG. 45, a climber can simultaneously unlock and open gate 30 with one hand. In FIG. 45, gate 30 is shown being pinched between the thumb and index finger so that the lock release is depressed (in FIG. 45, the force that moves the lock release is depicted by an outline arrow) thereby unlocking and opening gate 30.

FIGS. 34-37 show yet another alternate configuration of the instant invention. Referring to FIG. 34, compression spring 40 and pin 150 are loosely contained within gate 30. Compression spring 40 in conjunction with pin 150 and link 160 applies a force against body 20 adjacent but off-set inward from the center of hinge pin 36, thereby holding gate 30 closed.

As best seen in FIGS. 34 and 35, gate 30 is transverse by hole 138. The size of hole 138 is chosen so that the strength of gate 30 is not compromised. Locking member 170 is carried by gate 30 in hole 135. Sufficient clearance is provided between hole 138 and member 170 so that member 170 can move axially within hole 138 without binding.

Referring to FIG. 35, at the intersection of pin 150 with locking member 170, member 170 is transversed by elongated slot 178. Slot 178 allows end 158 of pin 150 to extend into member 170. Pin 150 in conjunction with slot 178 limits the axial movement of member 170 within hole 138.

End 158 of pin 150 abuts against surface 172 within slot 178 of member 170 when member 170 is in the locked position as shown by FIG. 34. Member 170 is maintained in the upright or locked position by spring 176 pushing the face of piston 174 against end 158 of pin 150. Piston 174 and compression spring 176 are loosely contained within locking member 170.

During the course of opening gate 30, link 160 pushes against and consequently moves pin 150 toward locking member 170. The movement of pin 150 compresses spring 40. The countering force of spring 40 against pin 150, and subsequently link 160, urges gate 30 to return to the closed position.

FIG. 34 pictures the inventive carabiner when it is locked. When the inventive carabiner is locked, gate 30 is prevented from pivoting around pin 26 because the abutment of pin end 158 against surface 172 of member 170 blocks movement of pin 150. Without the movement of pin 150, gate 30 cannot open.

Referring to FIG. 36, when a force is applied to member 170 in the direction of the outline arrow, member 170 will move relative to gate 30 to the position depicted in FIG. 36. Movement of member 170 compresses spring 176 against piston 174, which bears against end 158 of pin 150.

Preferably, pushing member 170 will first move it to the unlocked position and continued force will subsequently open gate 30. This sequence is accomplished by sizing spring 176 so that its compressive force is overcome before the closing force of spring 40 is overcome. Conversely, if an opening force is applied to gate 30 before member 170 moves to the unlocked position, end 158 of pin 150 will be jammed against surface 172 of member 170. When end 158 of pin 150 is jammed against surface 172 of member 170, member 170 will be unable to move to the unlocked position.

Movement of member 170 to the unlocked position shown in FIG. 36 moves surface 172 away from end 158 of pin 150, freeing pin 150 for axial movement. Continued force against member 170 or gate 30 in the direction of the outline arrow of FIG. 36 will cause pin 150 to slide further into slot 178 of member 170, thereby opening gate 30. FIG. 37 is a close-up view of the relationship of the various components when the gate is opening.

As described supra, when member 170 is at the locked position, gate 30 cannot move because member 170 blocks movement of pin 150 and consequently link 160. For this configuration to be assembled and function properly, manufacturing tolerances must be tightly controlled. For example, if one or more of the components are too short and there is a gap between end 158 and surface 172, excessive opening movement of gate 30 will occur even when locking member 170 is at the locked position. Conversely, if any one of the components is fabricated oversize, it may not be possible to properly assemble the carabiner. These problems are avoided b the alternate inventive carabiner configuration of FIG. 38.

The alternate inventive carabiner configuration of FIG. 38 incorporates setscrew 190 and ball 192. Setscrew 190 is threaded to gate 30 adjacent slot 178 of member 170. Referring to FIG. 39, ball 192 is carried by member 170 within the widest part of keyhole shaped slot 178.

Ball 192 is a rigid sphere, for example a stainless steel ball bearing. Alternately, ball 192 can be replaced with a short cylindrical pin, or the like. Ball 192 serves as a link between setscrew 190 and end 158 of pin 150.

End 158 of pin 150 abuts against ball 192 when member 170 is at the locked position. Member 170 is maintained in the upright or locked position by spring 174 pushing the face of piston 174 against end 158 of pin 150.

Ball 192 abuts against the end of setscrew 190. Ball 192 serves the same function as face 172 of the configuration depicted by FIG. 34. Setscrew 190 can be adjusted to compensate for dimensional variations of the various carabiner components. During assembly of the inventive carabiner, setscrew 190 is backed out to provide clearance between the components. After the inventive carabiner is assembled, setscrew 190 is threaded inward, pushing ball 192 until it just makes contact with end 158 of pin 150. At the point when ball 192 just makes contact with end 15b of pin 150, gate 30 will be unable to open unless member 170 is moved to the unlocked position.

Referring to FIG. 40, locking member 170 is shown at the unlocked position; therefore ball 192 is no longer located between setscrew 190 and end 156 of pin 150. As a consequence of the opening movement of gate 30, pin 150 has moved into the space formally occupied by ball 192.

FIG. 41 shows another alternate configuration of the inventive carabiner. Cantilever spring 180, located on top of and external to gate 30, replaces internal spring 176 and piston 174. As best seen in FIGS. 41 and 42, cantilever spring 180 is fabricated from rectangular spring stock, or alternately, can be formed or molded from plastic, for example nylon.

Cantilever spring 180 is firmly attached at end 184 to gate 30. The other end of cantilever spring 180 is loosely attached to member 170 by rivet 12. Loose attachment of cantilever spring 180 to member 170 is preferable to prevent binding when member 170 moves. Alternately, rivet 182 can be a screw, or the like, or can be a peened extension of member 170.

Referring to FIG. 43, ball 192 is carried by member 170 within the widest part of keyhole shaped slot 178. Referring to FIG. 41, setscrew 190 provides the means to adjust for dimensional variations of the various components as described supra.

The incorporation of cantilever spring 180 eliminates the need for a cavity in member 170 to house spring 176 and piston 174. Consequently, member 170 is less costly to fabricate and, also, can have a smaller cross-section. Furthermore, unlocking and opening the inventive carabiner with a single finger or a rope is facilitated because member 170 can be pushed to the unlocked position by applying force not only to the protruding end of member 170 but also by applying force anywhere along the exposed surface of cantilever spring 180.

FIG. 46 is a partial cross section of a typical prior art, non-locking carabiner. A comparison of the preferred inventive configuration of FIG. 4 with FIG. 46 will reveal that only two (2) additional components are needed to convert the prior art. A conversion to the preferred inventive locking configuration requires the replacement of link 161 with control 60 and the addition of spring pin 50 and setscrew 90. Gate 30 must be machined to accommodate control 60 and setscrew 90. Because the gate return spring provides the force that, in addition to closing the gate, holds the inventive locking mechanism either in the locked or unlocked states, the new components and accompanying modifications of the preferred configuration can be incorporated with little addition to the manufacturing cost of a basic carabiner. Consequently, a carabiner incorporating the preferred inventive locking mechanism can be sold with a relatively small price increase over the cost of a non-locking version.

The FIGS. illustrate a number of inventive locking configurations, all of which have several characteristics in common: all are contained within the carabiner gate, all function by disabling or blocking the gate return spring mechanism, and all are controlled by pushing an unobtrusive button, or-the-like, which protrudes from the gate.

Other variations on the shape and/or relative locations of the carabiner body, gate, spring, linkage and lock release are contemplated. It is understood that those skilled in the art may conceive of modifications and/or changes to the invention described above. Any such modifications or changes that fall within the purview of the description are intended to be included therein as well. This description is intended to be illustrative and is not intended to be limitative. The scope of the invention is limited only by the scope of the claims appended hereto.

I claim:

1. A carabiner comprising:
An oblong ring having a hinged gate adapted to have a closed position and an open position;
control means substantially within said gate; said control means having a first position and a second position;
said control means first position adapted to keep said gate closed; and
said control means second position adapted to enable said gate to move from said closed position to said open position.

2. The carabiner recited in claim 1 including:
forcing means; said control means at said second position enables said forcing means to move in response to movement of said gate from said closed position to said open position.

3. The carabiner recited in claim 2 wherein;
said control means second position transmits force from said forcing means for biasing said gate toward said closed position.

4. The carabiner recited in claim 2 wherein:
said control means at said second position transmits force to said forcing means thereby enabling said gate to move from said closed position to said open position.

5. The carabiner recited in claim 1 including:
operating means that selectively moves said control means from said first position to said second position.

6. The carabiner recited in claim 5 wherein:
said operating means selectively moves said control means from said second position to said first position

7. The carabiner recited in claim 1 wherein:
said control means first position adapted to block opening movement of said gate.

8. The control means recited in claim 2 wherein:
said first position is stable and said second position is stable, said stability provided by said forcing means.

9. The carabiner recited in claim 1 wherein:
A portion of said gate is hollow, said control means and said forcing means are substantially contained within said hollow portion of said gate.

10. A climbing aid comprising:
a C-shaped body having a first leg end and a second lee end;
an arm adapted to span the opening between said body first and second leg ends; said arm having a first end and a second end;
said arm first end hinged to said body first leg end;
forcing means within said arm;
control means substantially contained within said arm; said control means can be selectively moved from a first position to a second position;
said control means first position adapted to prevent separation of said arm from said body when said arm second end is adjacent said body second leg; and
said control means second position adapted to provide the transmission of force from said forcing means to said body first leg end for urging said arm second end toward said body second leg.

11. The climbing aid recited in claim 10 wherein:
said control means first position blocks movement of said forcing means; said control means second position allows movement of said forcing means.

12. A substantially oblong ring having a hinged gate adapted to provide a path to the inside of said ring; said gate comprising:
forcing means adapted to close said gate, said forcing means contained within said gate;
control means for directing the force provided by said forcing means, said control means substantially contained within said gate;
said control means has a first position and a second position; said control means can be selectively moved by finger pressure;
said first position prevents opening movement of said gate; and
said second position allows opening movement of said gate.
